(19) United States
(12) Patent Application Publication
(10) Pub. No.: US 2015/0172733 A1
(43) Pub. Date: Jun. 18, 2015

(54) CONTENT TRANSMISSION DEVICE, CONTENT PLAYBACK DEVICE, CONTENT DELIVERY SYSTEM, CONTROL METHOD FOR CONTENT TRANSMISSION DEVICE, CONTROL METHOD FOR CONTENT PLAYBACK DEVICE, DATA STRUCTURE, CONTROL PROGRAM, AND RECORDING MEDIUM

(71) Applicant: SHARP KABUSHIKI KAISHA, Osaka-shi, Osaka (JP)

(72) Inventors: Yasuaki Tokumo, Osaka-shi (JP); Maki Takahashi, Osaka-shi (JP)

(21) Appl. No.: 14/412,227

(22) PCT Filed: Jul. 1, 2013
(86) PCT No.: PCT/JP2013/067984

§ 371 Date: Dec. 31, 2014

(30) Foreign Application Priority Data
Jul. 10, 2012 (JP) 2012-155078

(51) Int. Cl. H04N 21/2662; H04N 21/262; H04N 21/643; H04N 21/458; H04N 21/24; H04N 21/239; H04N 21/647

(52) U.S. Cl. CPC H04N 21/2662; H04N 21/2393; H04N 21/262; H04N 21/64761; H04N 21/458; H04N 21/2407; H04N 21/64322

(57) ABSTRACT

In a case where a request from a client (2) requests transmission of a segment, a content transmission portion (22) of a server (1) waits until the segment is in a deliverable state and transmits a response that contains the segment to the client (2) after the segment is in the deliverable state. This enables reduction in delay and execution of high quality and low-latency live streaming.

### TECHNICAL FIELD

The present invention relates to a content transmission device that transmits a content, a content playback device that obtains and plays a content, a content delivery system, a control method for a content transmission device, a control method for a content playback device, a data structure, a control program, and a recording medium.

### BACKGROUND ART

With widespread use of the Internet and improved performance of computers, delivery of large-volume contents such as moving pictures via the Internet has widely been performed. For example, there is a service referred to as video on demand (VOD) that provides contents such as moving pictures in response to requests from users. For example, as PTL 1 describes, in VOD, data are transmitted and received between a server (content providing device) and a client (content playback device) by using the HyperText Transfer Protocol (HTTP).

Here, various technologies have been developed for delivery of contents by HTTP. For example, the Motion Picture Experts Group (MPEG) has been advancing international standardization of the MPEG-Dynamic Adaptive Streaming over HTTP (MPEG-DASH) standard which is an adaptive streaming technology using HTTP.

In MPEG-DASH, a content is divided into plural segments by time division and transmitted in segment units. Further, each of the segments is configured with single or plural fragments. Further, the content is configured with single or plural periods, and one period contains single or plural segments.

Further, in MPEG-DASH, plural representations in different qualities and types (playback qualities such as bit rate and image resolution and types such as data formats) are prepared for one content. For example, multiple pieces of segment data in which each segment is coded by different bit rates are prepared. Accordingly, a client that receives and plays the content may execute adaptive streaming by changing the bit rate of a requested content (segment) in response to a reception condition or the like of the content.

MPEG-DASH supports live streaming, and it is assumed that MPEG-DASH supports low-latency live streaming by reducing the length of the segment. Because processing delays due to the server and the client, delays on a network, and so forth occur, strictly real-time playback by the client is unfeasible. Thus, the live streaming that has a slight delay but is a substantially real-time live streaming is referred to as low-latency live streaming.

Further, in MPEG-DASH, a media presentation description (MPD) is associated with the content, and the content is managed by the MPD. MPD is metadata of the content and describes management information of the content in an XML format. In other words, MPD is information that is used when the client obtains and plays the content.

A specific description example of the MPD will be described based on FIG. 17. FIG. 17 is a diagram that illustrates a description example of the MPD. As illustrated in FIG. 17, in an MPD 200, information 210 that contains type information 211, profile information 212, buffering time information 213, MPD update interval information 214, and delivery starting time information 215 is described.

The type information 211 is information (an attribute value of an attribute “type”) that indicates whether the delivery is live delivery or on-demand delivery. In the example in the drawing, the attribute value of the attribute “type” is “dynamic” and indicates that the content associated with the MPD 200 is a live delivery content. On the other hand, in a case of the on-demand delivery, “static” is described in the attribute value of the attribute “type”.

The profile information 212 is information that indicates a profile of the content. Further, the buffering time information 213 is information that indicates a minimum buffering time. In the example in the drawing, the attribute value of an attribute “minBufferTime” is “PT10S”, thus indicating that the client performs buffering for at least 10 seconds.

The MPD update interval information 214 is information that indicates a minimum interval at which the client confirms with the server whether or not the MPD 200 has been updated. In the example in the drawing, the attribute value of an attribute “minimumUpdateperiod” is “PT60S”, thus indicating that the client confirms whether or not the MPD has been updated at least every 60 seconds.

The delivery starting time information 215 is information (the attribute value of an attribute “availabilityStartTime”) that indicates a time at which the server starts the live streaming delivery of the content. In the example in the drawing, the attribute value of the attribute “availabilityStartTime” is “2012-07-01T18:00:00”, thus indicating that the live streaming delivery is started at 18 o'clock on Jul. 1, 2012.

Further, in the MPD 200, obtainment source information 220 that indicates an obtainment source of the content is described. In the example in the drawing, a URL of the server is described as the obtainment source information 220.

Further, period information 230 about periods into which playback duration of the content is divided is described. In the example in the drawing, as the period information 230, a starting time of the period (the attribute value of an attribute “start”) with respect to the delivery starting time of the content and duration of the period (the attribute value of an attribute “duration”) are described.

Further, here, it is assumed that a high quality representation with a bit rate of 1024 kbps and a low quality representation with a bit rate of 512 kbps are prepared as the content. Thus, in the MPD 200, high quality segment information 241 that indicates a high quality segment and low quality segment information 242 that indicates a low quality segment are described as segments that are contained in a certain period (playback time from 0 to 60 seconds). In the high quality segment information 241, an ID and the bit rate of the high quality representation that is contained in the period are described. Further, the lengths and the URLs of the segments that are contained in the period are described. Further, the low quality segment information 242 is similar. The period is configured with 60 segments of segments #1 to #60.

Next, an operation sequence of the server and the client that execute the live streaming and HTTP messages that are transmitted and received in the live streaming will be described based on FIGS. 18 and 19. FIG. 18 is a diagram that illustrates one example of the operation sequence of the server and the client that execute the live streaming. Further, FIG. 19 is a diagram that illustrates one example of the HTTP messages that are transmitted and received in the live streaming.

Here, a time at which segment #i is able to be delivered is set as t(i). Delivery time t(i) of segment #i is calculated based on content delivery starting times that are indicated by the delivery starting time information 215 of the MPD 200 and the lengths of the segments.

As illustrated in FIGS. 18 and 19, the client first refers to the MPD 200 and transmits a request message 301 to request transmission of segment #n at time t(n) to the server. Because the request message 301 is transmitted after delivery time t(n) of segment #n, the server transmits a response message 302 that contains a data body of segment #n as a reply to the request message 301 to the client, and the client receives segment #n.

After the client receives segment #n, the client transmits a request message 303 to request transmission of next segment #n+1 to the server at time t(n+1). In this case also, because the request message 303 is transmitted after delivery time t(n+1) of segment #n+1, the server transmits a response message 304 that contains the data body of segment #n+1 as a reply to the request message 303 to the client, and the client receives segment #n+1.

The client next obtains segment #n+2 and segment #n+3 in a similar manner. Here, as illustrated in FIG. 18, a delay occurs while the client transmits the request for the segments and then receives the data bodies of the segments. Further, the delay fluctuates. Thus, in a case of reducing the length of the segment, it is difficult to stably execute the low-latency live streaming.

In general, prefetch is performed in order to reduce an influence of the fluctuation in the delay. Thus, an operation sequence of the server and the client and HTTP messages in a case where the prefetch is applied will be described based on FIGS. 20 and 21. FIG. 20 is a diagram that illustrates one example of the operation sequence of the server and the client in a case where the prefetch is applied. FIG. 21 is a diagram that illustrates one example of the HTTP messages in a case where the prefetch is applied.

As illustrated in FIGS. 20 and 21, the client first refers to the MPD 200 and transmits a request message 311 to request transmission of segment #n at time t(n) to the server. Because the request message 311 is transmitted after delivery time t(n) of segment #n, the server transmits a response message 312 that contains the data body of segment #n as a reply to the request message 311 to the client, and the client receives segment #n.

Here, immediately after the client receives segment #n by performing the prefetch, the client transmits a request message 313 to request transmission of next segment #n+1 to the server. However, the time point at which the server receives the request message 313 is earlier than delivery time t(n+1) of segment #n+1. Thus, the server transmits a response message 314 that indicates a reply error (no resource is present in the server, or segment data are not in a deliverable state) as a reply to the request message 313 to the client.

When the client receives the reply error, the client again transmits a request message 315 to request transmission of segment #n+1 to the server. In this case, because the request message 315 is transmitted after delivery time t(n+1) of segment #n+1, the server transmits a response message 316 that contains the data body of segment #n+1 as a reply to the request message 315 to the client, and the client receives segment #n+1.

When the client receives segment #n+1, the client immediately transmits a request message 317 to request transmission of next segment #n+2 to the server. Because the time point at which the server receives the request message 317 is later than delivery time t(n+2) of segment #n+2, the server transmits a response message 318 that contains the data body of segment #n+2 as a reply to the request message 317 to the client, and the client receives segment #n+2.

Then, when the client receives segment #n+2, the client immediately transmits a request message 319 to request transmission of next segment #n+3 to the server. However, in this case also, the time point at which the server receives the request message 319 is earlier than delivery time t(n+3) of segment #n+3. Thus, the server transmits a response message 320 that indicates the reply error as a reply to the request message 319 to the client.

When the client receives the reply error, the client again transmits a request message 321 to request transmission of segment #n+3 to the server. In this case, because the request message 321 is transmitted after delivery time t(n+3) of segment #n+3, the server transmits a response message 322 that contains the data body of segment #n+3 as a reply to the request message 321 to the client, and the client receives segment #n+3.

As described above, in the live streaming in MPEG-DASH, even if the prefetch is performed, an error is returned in a case where the request is made before the delivery time of the segment. Thus, a problem with the delay is not solved. On the contrary, a delay amount may increase due to reception processes for the reply errors, transmission processes for repeated requests, and so forth.

### CITATION LIST

### Patent Literature

PTL 1: Japanese Unexamined Patent Application Publication No. 2005-110244 (published on Apr. 21, 2005)

### Non Patent Literature

NPL 1: “ISO/IEC 23009-1”, [online], Apr. 1, 2012, ISO/IEC, [searched on Jun. 19, 2012], Internet <URL: http://standards.iso.org/ittf/PubliclyAvailableStandards/c057623_ISO_IEC_{—}23009-1_{—}2012.zip>

### SUMMARY OF INVENTION

### Technical Problem

A discussion will be held about a case where requests for the segments are transmitted by using a request pipeline of HTTP in the live streaming in MPEG-DASH. An operation sequence of the server and the client and HTTP messages in a case where the request pipeline is applied will be described based on FIGS. 22 and 23. FIG. 22 is a diagram that illustrates one example of the operation sequence of the server and the client in a case where the request pipeline is applied. Further, FIG. 23 is a diagram that illustrates one example of the HTTP messages in a case where the request pipeline is applied.

As illustrated in FIGS. 22 and 23, the client first refers to the MPD 200, forms request messages 331 to 334 to request transmission of segments #n to #n+3 at time t(n) into a pipeline, and transmits that to the server.

The server receives the request messages 331 to 334 and sequentially performs processes. Because the request message 331 is received after delivery time t(n) of segment #n, the server first transmits a response message 335 that contains the data body of segment #n as a reply to the request message 331 to the client. The request message 332 is received before delivery time t(n+1) of segment #n+1. Thus, the server next transmits a response message 336 that indicates the reply error as a reply to the request message 332 to the client. The request message 333 is received before delivery time t(n+2) of segment #n+2. Thus, the server then transmits a response message 337 that indicates the reply error as a reply to the request message 333 to the client. The request message 334 is received before delivery time t(n+3) of segment #n+3. Thus, the server finally transmits a response message 338 that indicates the reply error as a reply to the request message 334 to the client.

As described above, similarly to a case of the prefetch, even if the request pipeline is performed, an error is returned in a case where the requests are made before the delivery times of the segments. Thus, the problem with the delay is not solved. On the contrary, the delay amount may increase due to the reception processes for the reply errors, the transmission processes for the repeated requests, and so forth.

That is, in the live streaming in MPEG-DASH, the problem with the delay may not be solved even if related art is simply applied.

The present invention has been made in consideration of the above problems, and an object thereof is to provide a content transmission device, a content playback device, a content delivery system, a control method for a content transmission device, a control method for a content playback device, a data structure, a control program, and a recording medium that reduce delay and execute high quality and low-latency live streaming.

### Solution to Problem

To solve the above problems, a content transmission device according to the present invention is a content transmission device that transmits a content which is configured with plural segments to a content playback device on a segment-by-segment basis, the content transmission device including transmission means that transmits a response to the content playback device as a reply to a request in a case where the request is received from the content playback device, in which in a case where the request requests transmission of a segment, the transmission means waits until the segment is in a deliverable state and transmits a response that contains the segment to the content playback device after the segment is in the deliverable state.

Further, to solve the above problems, a control method for a content transmission device according to the present invention is a control method for a content transmission device that transmits a content which is configured with plural segments to a content playback device on a segment-by-segment basis, the control method including a transmission step of transmitting a response to the content playback device as a reply to a request in a case where the request is received from the content playback device, in which in a case where the request requests transmission of a segment, the transmission step pauses until the segment is in a deliverable state, and a response that contains the segment is transmitted to the content playback device after the segment is in the deliverable state.

In the above configuration, the transmission means transmits the response that contains the segment to the content playback device after the segment is in the deliverable state. Thus, even in a case where the request that requests transmission of the segment is received before the segment is in the deliverable state, a response that indicates a reply error is not transmitted. In addition, the content playback device does not need to again transmit the request. Accordingly, an effect of enabling reduction in delay and execution of high quality and low-latency live streaming may be provided.

Further, in the content transmission device according to the present invention, the transmission means preferably determines whether or not a segment is in the deliverable state based on content management information that is associated with the content.

Further, in the content transmission device according to the present invention, the transmission means preferably determines whether or not a segment is in the deliverable state based on a delivery time of the segment that is added to the request.

Further, in the content transmission device according to the present invention, in a case where the request requests transmission of a segment and a predetermined time or longer is taken until the segment is in the deliverable state after the request is received, the transmission means preferably notifies the content playback device of a status that indicates that a process is in progress.

For example, in a case where the content playback device does not receive a response within a predetermined time after the request is transmitted, the content playback device is caused to time out. In this case also, as in the above configuration, in a case where the predetermined time or longer is taken until the segment is in the deliverable state after the request is received, the transmission means notifies the content playback device of the status that indicates that a process is in progress. Thus, a time-out may be avoided.

Further, to solve the above problems, a content playback device according to the present invention is a content playback device that obtains a content which is configured with plural segments from a content transmission device on a segment-by-segment basis and plays the content, the content playback device including obtainment means that transmits a request that requests transmission of each of the segments to the content transmission device and obtains a response that contains the segment as a reply to the request, in which the obtainment means transmits requests that request transmission of the segments before delivery times of the segments.

Further, to solve the above problems, a control method for a content playback device according to the present invention is a control method for a content playback device that obtains a content which is configured with plural segments from a content transmission device on a segment-by-segment basis and plays the content, the control method including an obtainment step of transmitting a request that requests transmission of each of the segments to the content transmission device and obtaining a response that contains the segment as a reply to the request, in which, in the obtainment step, requests that request transmission of the segments are transmitted before delivery times of the segments.

In the above configuration, the obtainment means transmits requests that request transmission of the segments before the delivery times of the segments. Thus, in a case where the content transmission device waits until the segment is in the deliverable state with respect to the request that comes in before the delivery time of the segment and then transmits the response that contains the segment to the content playback device after the segment is in the deliverable state, the content transmission device performs a transmission process of the response when the segment is in the deliverable state, thus enabling reduction in a delay at a time when the content playback device obtains the segment. Accordingly, the effect of enabling reduction in delay and execution of high quality and low-latency live streaming may be provided.

Further, in the content playback device according to the present invention, the obtainment means preferably transmits a request that requests transmission of a segment whose playback sequence is later before obtaining a response to a request that requests transmission of a segment whose playback sequence is earlier is completed.

In the above configuration, even in a case where continuous segments in shorter segment lengths are obtained, an influence of a fluctuation of the delay may be reduced, and the low-latency live streaming may thus be more stably executed.

Further, in the content playback device according to the present invention, the obtainment means preferably transmits plural requests that request transmission of segments by forming the plural requests into a pipeline.

Further, in the content playback device according to the present invention, the obtainment means preferably transmits the request to which a delivery time of a segment is added.

In the above configuration, the content playback device notifies the content transmission device of the delivery time of the segment, and the content transmission device determines whether or not the segment is in the deliverable state based on the notified delivery time. Thus, the content playback device may control a transmission timing of the segment of the content transmission device.

Further, a content delivery system according to the present invention preferably includes the content transmission device and the content playback device.

In the above configuration, the content delivery system provides a similar effect to the content transmission device and the content playback device.

Further, to solve the above problems, a relay device according to the present invention is a relay device that is interposed between a content playback device and a content transmission device, the relay device including transfer means that transfers a request which is transmitted from the content playback device to the content transmission device and transfers a response which is transmitted from the content transmission device as a reply to the request to the content playback device, in which a content is configured with plural segments, and in a case where the request which is transmitted from the content playback device requests transmission of a segment, the transfer means waits until the segment is in a deliverable state and transmits the request to the content transmission device after the segment is in the deliverable state.

Further, in the relay device according to the present invention, in a case where the request which is transmitted from the content playback device requests transmission of a segment and a predetermined time or longer is taken until a response that contains the segment is obtained from the content transmission device after the request is received, the transfer means preferably notifies the content playback device of a status that indicates that a process is in progress.

Further, in the relay device according to the present invention, in a case where the request which is transmitted from the content playback device requests transmission of a segment and a delivery time of the segment is added to the request, the transfer means preferably transmits the request to the content transmission device after the delivery time of the segment.

Further, a data structure of content management information that is associated with a content which is configured with plural segments which a content playback device obtains from a content transmission device, the data structure including a prefetch feasible-unfeasible flag that indicates whether or not prefetch is feasible, is included in the scope of the present invention.

Further, a data structure of a request by which a content playback device requests a content transmission device to transmit segments which configure a content, in which a header of the request contains segment delivery time information that indicates a delivery time of the segment, is included in the scope of the present invention.

The content transmission device and the content playback device may be realized by a computer. In this case, a control program that causes a computer to operate as the means of the content transmission device and the content playback device and thereby realizes the content transmission device and the content playback device by the computer, and a recording medium that is readable by a computer and stores the control program are included in the scope of the present invention.

### Advantageous Effects of Invention

As described above, a content transmission device according to the present invention includes transmission means that transmits a response to the content playback device as a reply to a request when the request is received from the content playback device, in which in a case where the request requests transmission of the segment, the transmission means waits until the segment is in a deliverable state and transmits a response that contains the segment to the content playback device after the segment is in the deliverable state.

Further, a control method for a content transmission device according to the present invention includes a transmission step of transmitting a response to the content playback device as a reply to a request when the request is received from the content playback device, in which in a case where the request requests transmission of the segment, the transmission step pauses until the segment is in a deliverable state, and a response that contains the segment is transmitted to the content playback device after the segment is in the deliverable state.

Accordingly, an effect of enabling reduction in delay and execution of high quality and low-latency live streaming may be provided.

Further, a content playback device according to the present invention includes obtainment means that transmits a request that requests transmission of each of the segments to the content transmission device and obtains a response that contains the segment as a reply to the request, in which the obtainment means transmits requests that request transmission of the segments before delivery times of the segments.

Further, a control method for a content playback device according to the present invention includes an obtainment step of transmitting a request that requests transmission of each of the segments to the content transmission device and obtaining a response that contains the segment as a reply to the request, in which in the obtainment step, requests that request transmission of the segments are transmitted before delivery times of the segments.

Accordingly, the effect of enabling reduction in delay and execution of high quality and low-latency live streaming may be provided.

### BRIEF DESCRIPTION OF DRAWINGS

FIG. 1 is a diagram that illustrates an embodiment of the present invention and illustrates one example of main configurations of a server and a client.

FIG. 2 is a block diagram that illustrates one example of a configuration of a content delivery system that includes the server and the client.

FIG. 3 is a flowchart that illustrates one example of a content transmission process of the server.

FIG. 4 is a flowchart that illustrates one example of a content obtainment process of the client.

FIG. 5 is a diagram that illustrates a description example of an MPD that is used in the present invention.

FIG. 6 is a diagram that illustrates one example of an operation sequence of the server and the client that execute live streaming.

FIG. 7 is a diagram that illustrates one example of HTTP messages that are transmitted and received in the live streaming.

FIG. 8 is a block diagram that illustrates one example of a configuration of the content delivery system that includes a proxy server.

FIG. 9 is a diagram that illustrates one example of an operation sequence of the server and the client that notifies a status that indicates that a process is in progress.

FIG. 10 is a diagram that illustrates one example of an HTTP message that notifies the status that indicates that a process is in progress.

FIG. 11 is a diagram that illustrates one example of an operation sequence of the server, the client, and the proxy server that notifies the status that indicates that a process is in progress.

FIG. 12 is a diagram that illustrates one example of the HTTP message that notifies the status that indicates that a process is in progress.

FIG. 13 is a diagram that illustrates one example of an operation sequence in a case where the server determines whether or not a segment is in a deliverable state based on a delivery time of the segment that is added to a request.

FIG. 14 is a diagram that illustrates one example of an HTTP request message to which the delivery time of the segment is added.

FIG. 15 is a diagram that illustrates one example of an operation sequence in a case where the proxy server controls transmission timings of the requests to the server based on the delivery times of the segments that are added to the requests transmitted from the client.

FIG. 16 is a diagram that illustrates one example of the HTTP request message to which the delivery time of the segment is added.

FIG. 17 is a diagram that illustrates a description example of the MPD in related art.

FIG. 18 is a diagram that illustrates one example of the operation sequence of the server and the client that execute the live streaming.

FIG. 19 is a diagram that illustrates one example of HTTP messages that are transmitted and received in the live streaming.

FIG. 20 is a diagram that illustrates one example of an operation sequence of the server and the client in a case where the prefetch is applied.

FIG. 21 is a diagram that illustrates one example of HTTP messages in a case where the prefetch is applied.

FIG. 22 is a diagram that illustrates one example of an operation sequence of the server and the client in a case where the request pipeline is applied.

FIG. 23 is a diagram that illustrates one example of HTTP messages in a case where the request pipeline is applied.

### DESCRIPTION OF EMBODIMENTS

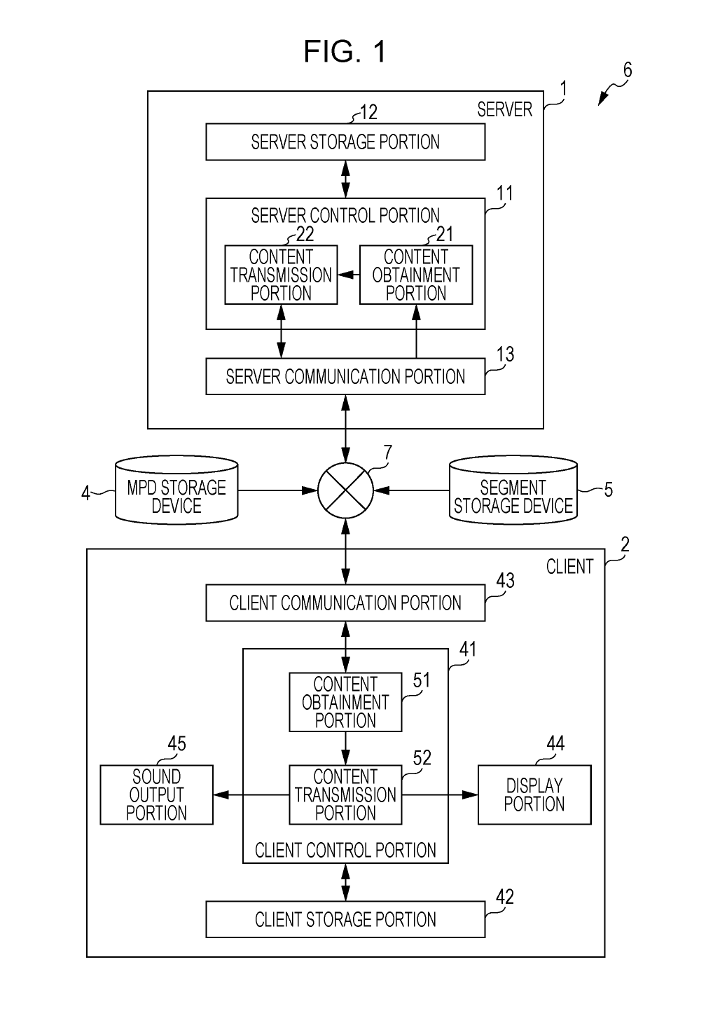

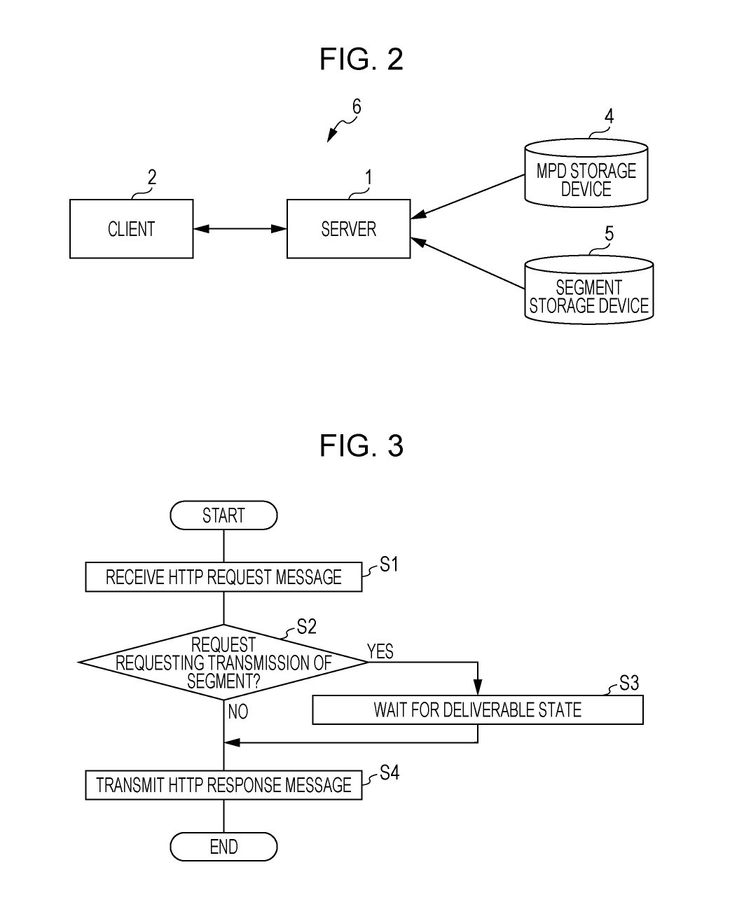

One embodiment of the present invention will hereinafter be described based on FIGS. 1 to 16. An outline of a content delivery system of this embodiment will first be described based on FIG. 2.

[Outline of Content Delivery System]

FIG. 2 is a diagram that illustrates the outline of a content delivery system 6 according to this embodiment. As illustrated in FIG. 2, the content delivery system 6 includes a server 1, a client 2, an MPD storage device 4, and a segment storage device 5.

As illustrated in FIG. 2, the client 2 connects with the server 1. Further, the server 1 connects with the MPD storage device 4 and the segment storage device 5. The devices are connected by an arbitrary network of wired communication or wireless communication.

The server 1 is a content transmission device that receives a request for transmission of a content from the client 2 and transmits the content. The server 1 in advance transmits MPD data to the client 2 before transmitting a data body (segment data) of the content. The server 1 obtains the MPD data and the segment data from the MPD storage device 4 and the segment storage device 5 on a network 7. However, the server 1 is not limited to this. For example, servers 1 may locally retain the MPD data and the segment data.

The client 2 is a content playback device that plays a content obtained from another device such as the server 1 or a content stored in the own device. The client 2 may be a digital television, a recorder, a set top box (STB), a PC, a cellular phone, a smart phone, a game console, a personal digital assistant (PDA), a digital camera, a digital video, or the like, for example.

Further, the configuration of the content delivery system 6 is not limited to an example illustrated in FIG. 2. For example, the content delivery system 6 may include plural servers 1 or may include plural clients 2. Further, the content delivery system 6 may include single or plural proxy servers 3 that relay data between the server 1 and the client 2.

Further, in this embodiment, HTTP that is widely used as a Hypertext Transfer Protocol is used as a transmission protocol on the network in the content delivery system 6. Further, it is assumed that contents that are delivered by the server 1 are video contents and the contents are segmented ISOBFF data. That is, in this embodiment, the content delivery system 6 delivers contents based on the above-described MPEG-DASH standard.

[Configurations of Devices]

Main configurations of the server 1 and the client 2 will next be described based on FIG. 1. FIG. 1 is a diagram that illustrates one example of the main configurations of the server 1 and the client 2.

(Server)

As illustrated in FIG. 1, the server 1 is configured to include a server control portion 11, a server storage portion 12, and a server communication portion 13.

The server communication portion 13 performs communication with the other devices such as the client 2, the MPD storage device 4, and the segment storage device 5 by wireless communication means or wired communication means and performs interchanges of data by following instructions of the server control portion 11.

The server control portion 11 executes programs that are read out from the server storage portion 12 to a temporary storage portion (not illustrated), thereby performs various kinds of computations, and performs integrated control of portions included in the server 1.

In this embodiment, the server control portion 11 is configured to include a content obtainment portion 21 and a content transmission portion (transmission means) 22 as function blocks. A central processing unit (CPU) reads out programs stored in a storage device that is realized by a read only memory (ROM) or the like to a temporary storage device that is realized by a random access memory (RAM) or the like and executes the programs, and the function blocks (21 and 22) of the server control portion 11 may thereby be realized.

The content obtainment portion 21 obtains the MPD data from the MPD storage device 4 or the segment data from the segment storage device 5 based on instructions from the content transmission portion 22. The content obtainment portion 21 outputs the obtained MPD data or segment data to the content transmission portion 22.

The content obtainment portion 21 may in advance obtain the MPD data and/or the segment data regardless of presence or absence of the instruction from the content transmission portion 22. In this case, the content obtainment portion 21 stores the MPD data and the segment data that are in advance obtained in the server storage portion 12 and reads out the MPD data and the segment data from the server storage portion 12 based on the instructions from the content transmission portion 22.

When the content transmission portion 22 receives the request from the client 2, the content transmission portion 22 determines whether or not the received request is a request that requests transmission of the segment. In a case where the received request is the request that requests transmission of the segment, the content transmission portion 22 instructs the content obtainment portion 21 to obtain the segment, and the content obtainment portion 21 waits until the segment is in a deliverable state (available). The content transmission portion 22 then obtains the segment data from the content obtainment portion 21 when the segment is in the deliverable state and transmits a response that contains the segment data to the client 2.

On the other hand, in a case where the received request is not the request that requests transmission of the segment, the content transmission portion 22 transmits a response to the request to the client 2. For example, when the content transmission portion 22 receives a request that requests transmission of content management information (MPD) from the client 2, the content transmission portion 22 instructs the content obtainment portion 21 to obtain the MPD of the content. When the transmission portion 22 obtains the MPD data from the content obtainment portion 21, the content transmission portion 22 transmits a response that contains the obtained MPD data to the client 2. Further, when the content transmission portion 22 receives a request that requests transmission of a resource such as a web page from the client 2, the content transmission portion 22 instructs the content obtainment portion 21 to obtain the resource. When the content transmission portion 22 obtains the resource from the content obtainment portion 21, the content transmission portion 22 transmits a response that contains the obtained resource to the client 2.

The content transmission portion 22 may determine whether or not the received request is the request that requests transmission of the segment based on whether or not a media type of the resource specified by the received request is a segment.

The content transmission portion 22 may determine whether or not the segment is in the deliverable state based on a delivery time of the segment. That is, the content transmission portion 22 determines that the segment is not in the deliverable state before the delivery time of the segment and determines that the segment is in the deliverable state after the delivery time of the segment.

The server storage portion 12 stores programs, data, and so forth to which the server control portion 11 refers and may store the MPD data, the segment data, and so forth that are obtained by the content obtainment portion 21, for example.

(Client)

As illustrated in FIG. 1, the client 2 includes a client control portion 41, a client storage portion 42, a client communication portion 43, a display portion 44, and a sound output portion 45. The client 2 may include members such as an operating portion and a sound input portion. However, the members are not illustrated because those are not related to the characterizing points of the invention.

The client communication portion 43 performs communication with the other devices such as the server 1 and the proxy server 3 by wireless communication means or wired communication means and performs interchanges of data by following instructions of the client control portion 41.

The display portion 44 displays images by following instructions of the client control portion 41. It is sufficient that the display portion 44 displays images by following the instructions of the client control portion 41. For example, a liquid crystal display (LCD), an organic EL display, a plasma display, or the like may be applied.

The sound output portion 45 receives electric signals from the client control portion 41, converts the received electric signals into sound, and outputs the sound to the outside of the client 2. The sound output portion 45 is a so-called speaker.

The client control portion 41 executes programs that are read out from the client storage portion 42 to a temporary storage portion (not illustrated), thereby performs various kinds of computations, and performs integrated control of portions included in the client 2.

In this embodiment, the client control portion 41 is configured to include a content obtainment portion (obtainment means) 51 and a content playback portion 52 as function blocks. A CPU reads out programs stored in a storage device that is realized by a ROM or the like to a temporary storage device that is realized by a RAM or the like and executes the programs, and the function blocks (51 and 52) of the client control portion 41 may thereby be realized.

The content obtainment portion 51 transmits a request to the server 1 via the client communication portion 43 and obtains the content (the MPD associated with the content and the segments that configure the content) from the server 1.

Specifically, when an obtainment (playback) instruction of the content is input from a user via the operating portion (not illustrated), the content obtainment portion 51 transmits a request that requests transmission of management information (MPD) of the content to the server 1. The content obtainment portion 51 then receives the MPD data of the content as a response to the request. The content obtainment portion 51 refers to the received MPD data and transmits requests that request transmission of the segments that configure the content to the server 1. The content obtainment portion 51 then obtains the segment data of the content as a response to the request. The content obtainment portion 51 outputs the obtained segment data to the content playback portion 52.

As illustrated in FIG. 16, normally, the content obtainment portion 51 refers to the MPD and transmits the request for the segment at the delivery time of the segment (or after the delivery time). Further, the content obtainment portion 51 obtains a first segment (receives a response to the request for the first segment) and thereafter transmits a request for a next segment, thereby obtaining the segments one by one.

In the present invention, a prefetch feasible-unfeasible flag (details will be described below) is described in the MPD. In a case where the prefetch feasible-unfeasible flag described in the MPD indicates that the prefetch is feasible, the content obtainment portion 51 transmits the request for the segment before the delivery time of the segment. Further, in a case where the prefetch feasible-unfeasible flag described in the MPD indicates that the prefetch is feasible, the content obtainment portion 51 transmits the request for the next segment before obtainment of the first segment is completed (without waiting for a response to the request for the first segment). For example, the content obtainment portion 51 transmits plural HTTP requests that request transmission of the segments by forming the HTTP requests into a pipeline.

When the content playback portion 52 obtains the segment data from the content obtainment portion 51, the content playback portion 52 refers to the MPD data and plays the content based on the obtained segment data.

The client storage portion 42 stores programs, data, and so forth to which the client control portion 41 refers and may store the MPD data, the segment data, and so forth that are obtained by the content obtainment portion 51, for example.

[Processing in Server]

A content transmission process of the server 1 will next be described based on FIG. 3. FIG. 3 is a flowchart that illustrates one example of the content transmission process of the server 1.

As illustrated in FIG. 3, the server 1 waits until an HTTP request message is transmitted from the client 2. Then, when the server 1 receives the HTTP request message (S1), the server 1 determines whether or not the received HTTP request message is an HTTP request message that requests transmission of the segment (S2).

In a case where the received HTTP request message is the HTTP request message that requests transmission of the segment (YES in S2), the content transmission portion 22 instructs the content obtainment portion 21 to obtain the segment, obtains the segment data from the content obtainment portion 21, and waits until the segment is in the deliverable state (available) (S3). The content transmission portion 22 then transmits a response that contains the segment data to the client 2 when the segment is in the deliverable state (S4).

On the other hand, in a case where the received HTTP request message is not the HTTP request message that requests transmission of the segment (NO in S2), the content transmission portion 22 transmits a response to the request to the client 2 (S4).

[Processing in Client]

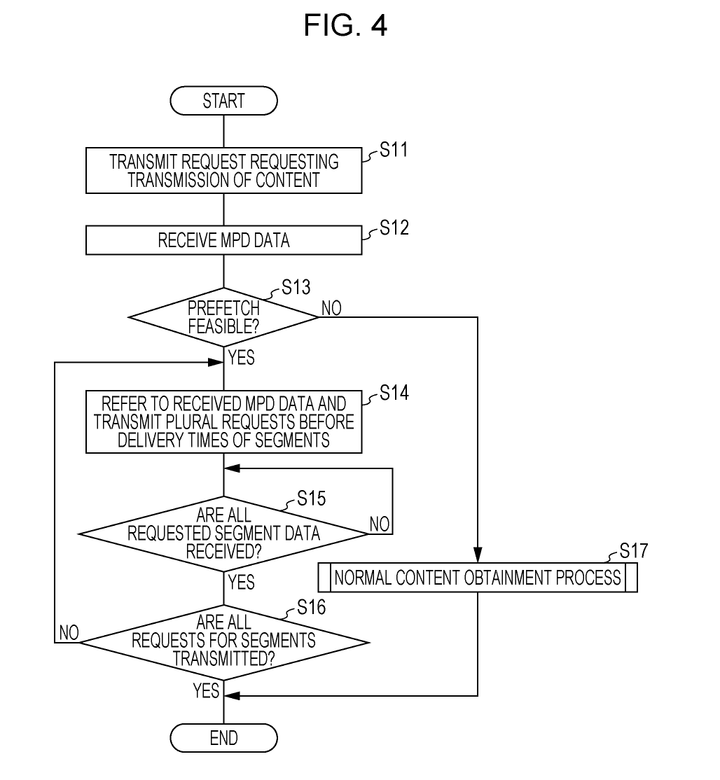

A content obtainment process of the client 2 will next be described based on FIG. 4. FIG. 4 is a flowchart that illustrates one example of the content obtainment process of the client 2.

As illustrated in FIG. 4, the content obtainment portion 51 first transmits a request that requests transmission of the content management information (MPD) to the server 1 (S11). The content obtainment portion 51 then receives a response to the request and obtains the MPD data that are contained in the response (S12).

The content obtainment portion 51 then refers to the prefetch feasible-unfeasible flag that is described in the received MPD data and thereby determines whether or not the prefetch is feasible (S13). In a case where the prefetch is feasible, the content obtainment portion 51 refers to the received MPD data and transmits plural requests that request transmission of continuous plural segments before the respective delivery times of the segments (S14).

The content obtainment portion 51 simultaneously performs a reception process of the response with a transmission process of the request and sequentially obtains the segments. In a case where the content obtainment portion 51 obtains all the segments that are requested in S14 (YES in S15) and completes transmission of requests for all the segments that configure the content (YES in S16), the content obtainment portion 51 finishes the content obtainment process.

In a case where the prefetch is not feasible in S13 (NO in S13), the content obtainment portion 51 executes a normal content obtainment process (S17). Thus, a description thereof will not be made here.

The content obtainment portion 51 sequentially outputs the obtained segments to the content playback portion 52, and the content playback portion 52 simultaneously plays the content based on the obtained segments with the above-described content obtainment process.

[Description Example of MPD]

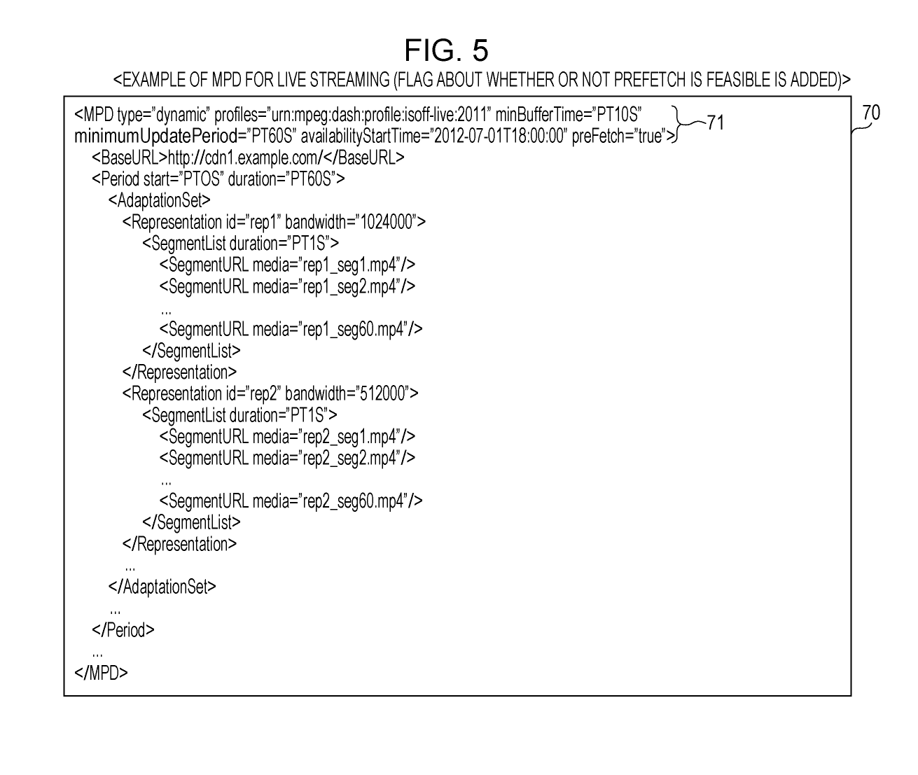

A description example of the MPD that is used in the present invention will next be described based on FIG. 5. FIG. 5 is a diagram that illustrates the description example of the MPD that is used in the present invention.

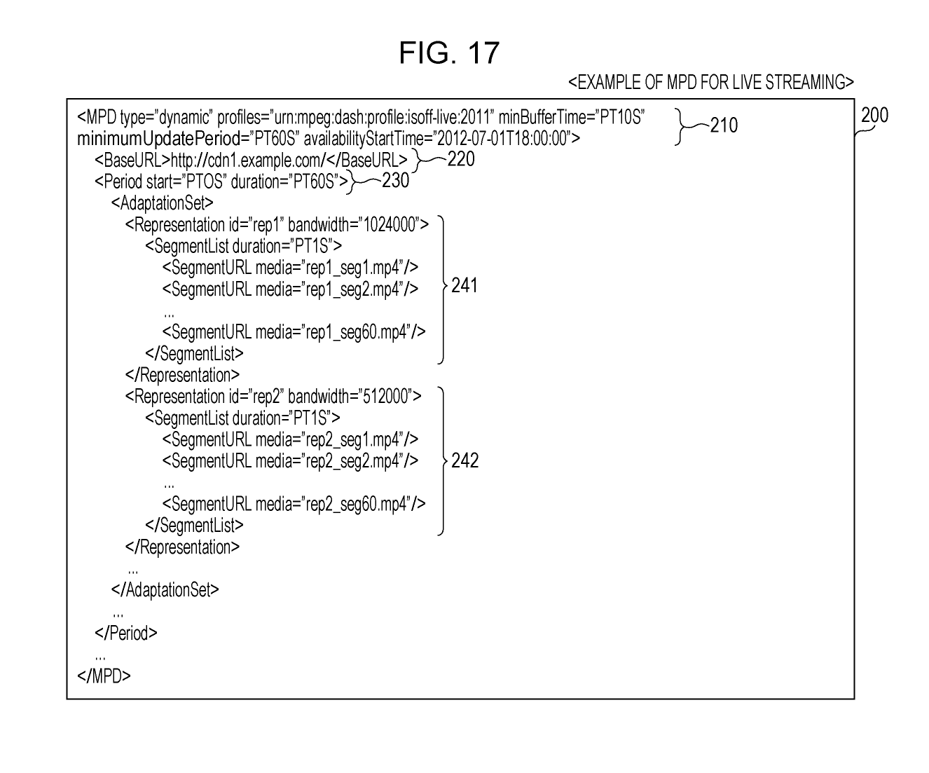

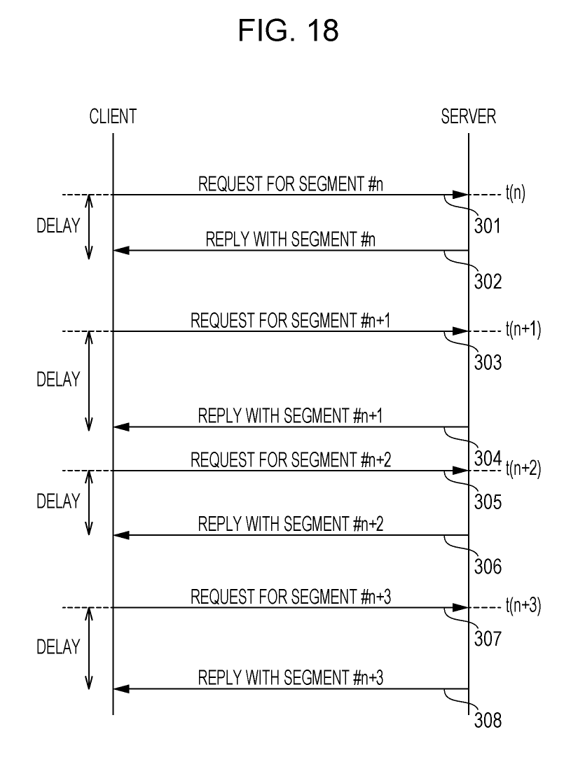

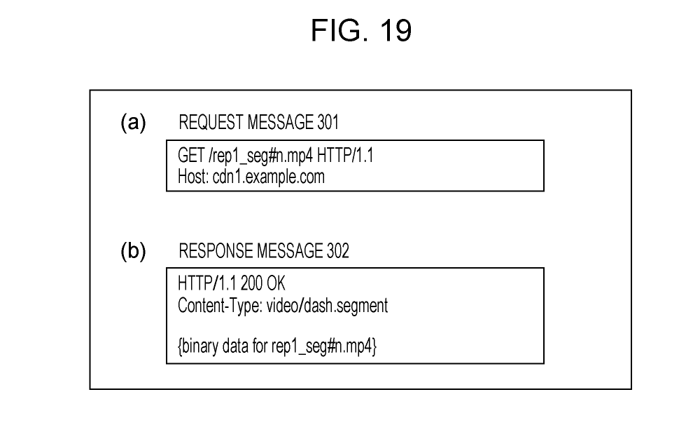

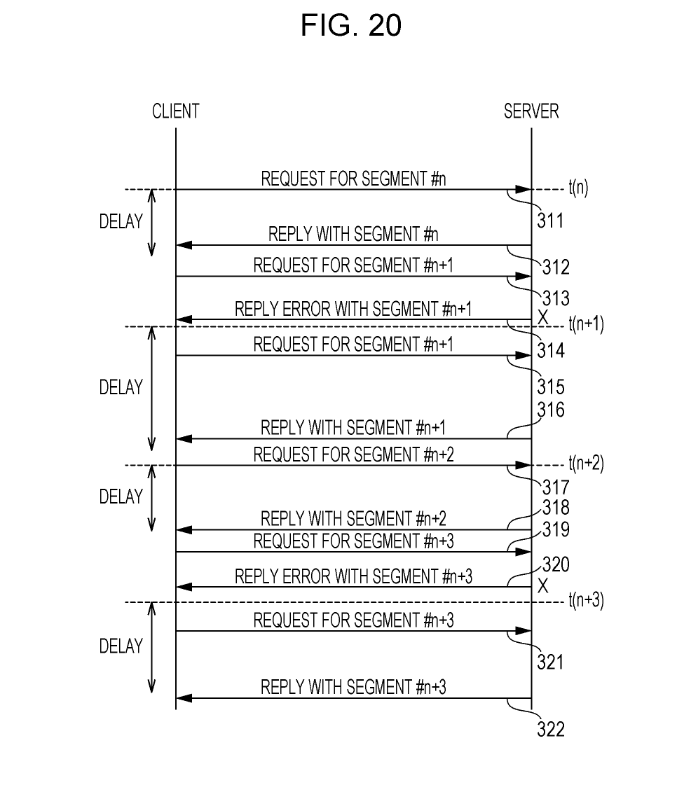

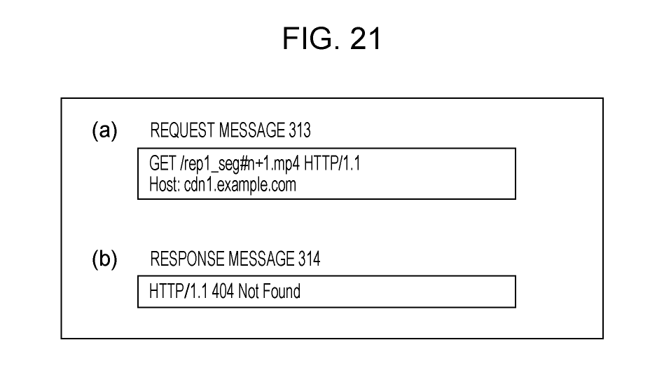

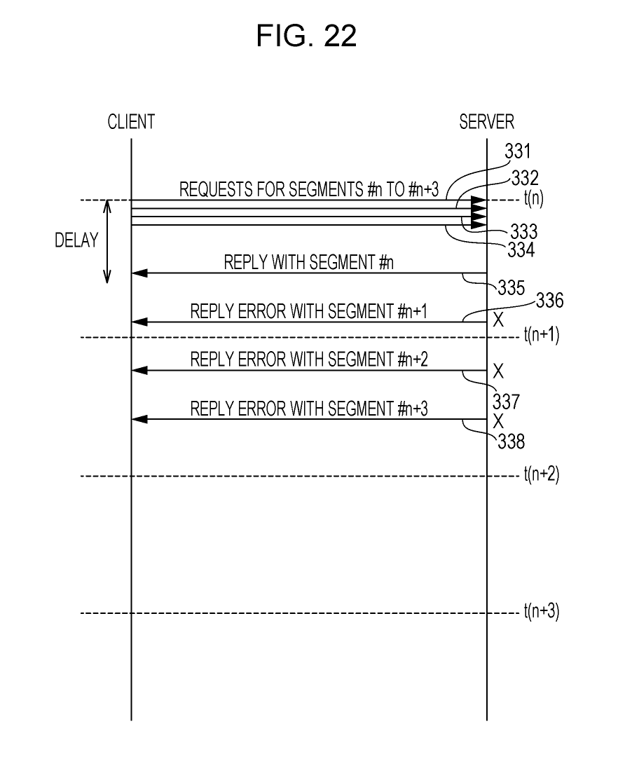

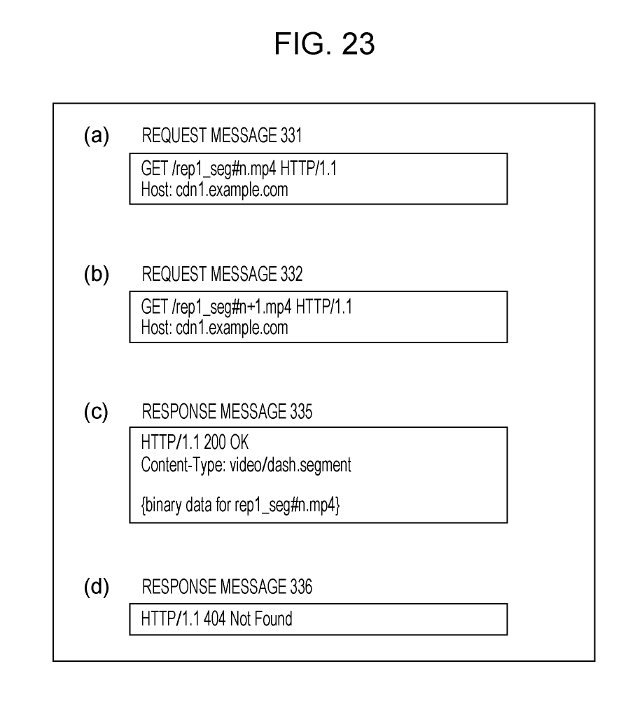

As illustrated in FIG. 5, in an MPD 70 that is used in the present invention, the prefetch feasible-unfeasible flag is further added to an MPD 200 in related art that is illustrated in FIG. 17. Specifically, the prefetch feasible-unfeasible flag is added to information 210 of the MPD 200 in related art. As illustrated in FIG. 5, an attribute “preFetch” is described as the prefetch feasible-unfeasible flag in information 71 of the MPD 70 used in the present invention, and “true” that indicates the prefetch is feasible is described as an attribute value of the attribute “preFetch”. In a case where the prefetch is not feasible, “false” is described in the attribute value.

### First Embodiment

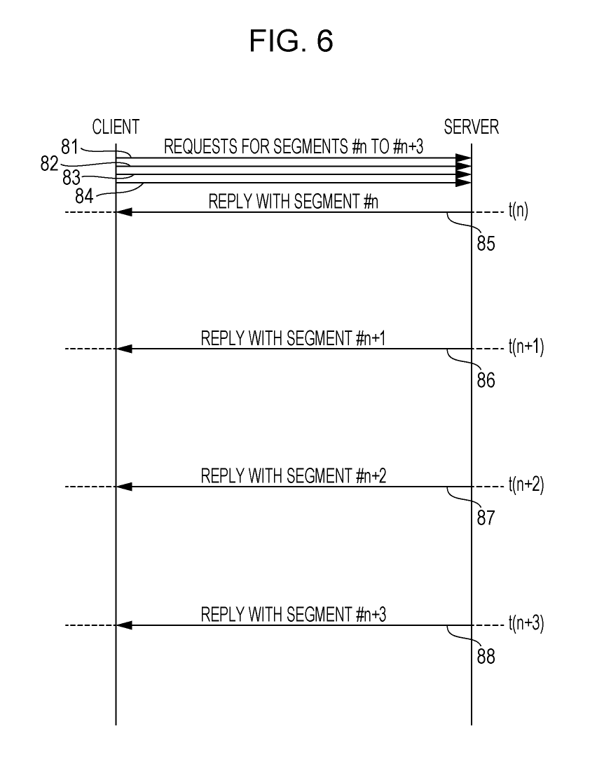

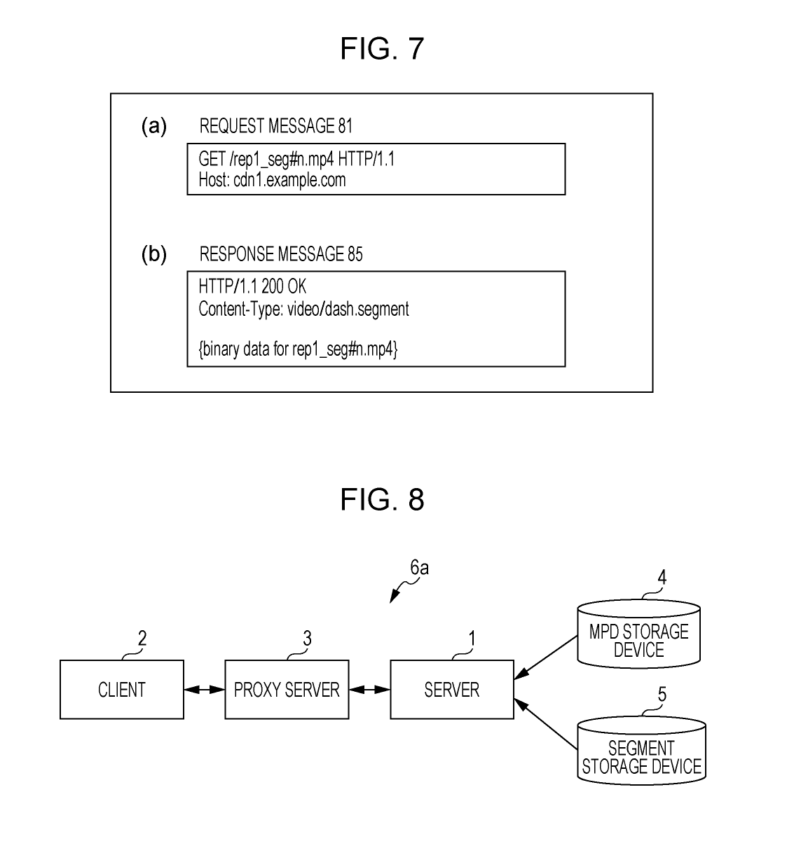

Next, an operation sequence of the server 1 and the client 2 that execute the live streaming and HTTP messages that are transmitted and received in the live streaming will be described based on FIGS. 6 and 7. FIG. 6 is a diagram that illustrates one example of the operation sequence of the server 1 and the client 2 that execute the live streaming. Further, FIG. 7 is a diagram that illustrates one example of the HTTP messages that are transmitted and received in the live streaming.

Here, it is assumed that the client 2 refers to the MPD 70, forms requests for four segments #n to #n+3 into a pipeline, and transmits that before delivery time t(n) of segment #n.

As illustrated in FIGS. 6 and 7, the client 2 first refers to the MPD 70, forms request messages 81 to 84 to request transmission of segments #n to #n+3 into a pipeline, and transmits that to the server 1 before time t(n).

The server 1 waits until the delivery times of segments #n to #n+3 because the request messages 81 to 84 request transmission of the segments. Then, at delivery time t(n) of segment #n, the server 1 transmits a response message 85 that contains the data body of segment #n as a reply to the request message 81 to the client 2, and the client 2 receives segment #n.

Further, at delivery time t(n+1) of segment #n+1, the server 1 transmits a response message 86 that contains the data body of segment #n+1 as a reply to the request message 82 to the client 2, and the client 2 receives segment #n+1. Further, at delivery time t(n+2) of segment #n+2, the server 1 transmits a response message 87 that contains the data body of segment #n+2 as a reply to the request message 83 to the client 2, and the client 2 receives segment #n+2. Further, at delivery time t(n+3) of segment #n+3, the server 1 transmits a response message 88 that contains the data body of segment #n+3 as a reply to the request message 84 to the client 2, and the client 2 receives segment #n+3.

As described above, the client 2 transmits the requests before the delivery times of the segments, and the server 1 waits until the delivery times and transmits the responses to the requests, thereby enabling reduction in an influence of a fluctuation in a delay. Thus, high quality and low-latency live streaming that may handle NW jitter may be executed.

[First Modification]

In this embodiment, the content delivery system 6 includes the server 1, the client 2, the MPD storage device 4, and the segment storage device 5 and may further include a proxy server. Specifically, as illustrated in FIG. 8, a content delivery system 6a may include the server 1, the client 2, the proxy server 3, the MPD storage device 4, and the segment storage device 5.

As illustrated in the drawing, the client 2 connects with the server 1 via the proxy server 3. Further, the content delivery system 6a may include plural proxy servers 3.

The proxy server 3 is a relay device that is interposed between the server 1 and the client 2 and includes transfer means (not illustrated) that transfers the request transmitted from the client 2 to the server 1 and the response transmitted from the server 1 to the client 2. Further, the proxy server 3 may include a proxy server storage portion (not illustrated) and may store the requests transmitted from the client 2, the response transmitted from the server 1, the segment data contained in the responses, and so forth.

(Second Modification)

In this embodiment, because the client 2 transmits the requests before the delivery times of the segments, an interval between transmission of the request and reception of the response to the request may be long. In this case, a time-out may occur depending on a configuration, and the client 2 again has to transmit the request. Accordingly, in order to avoid the time-out and transmission of the repeated request, in a case where the server 1 is not able to transmit the response to the request within a predetermined time from reception of the request that requests transmission of the segment (a case where the segment is not in the deliverable state), the server 1 may notify the client 2 of a status that indicates a process is in progress.

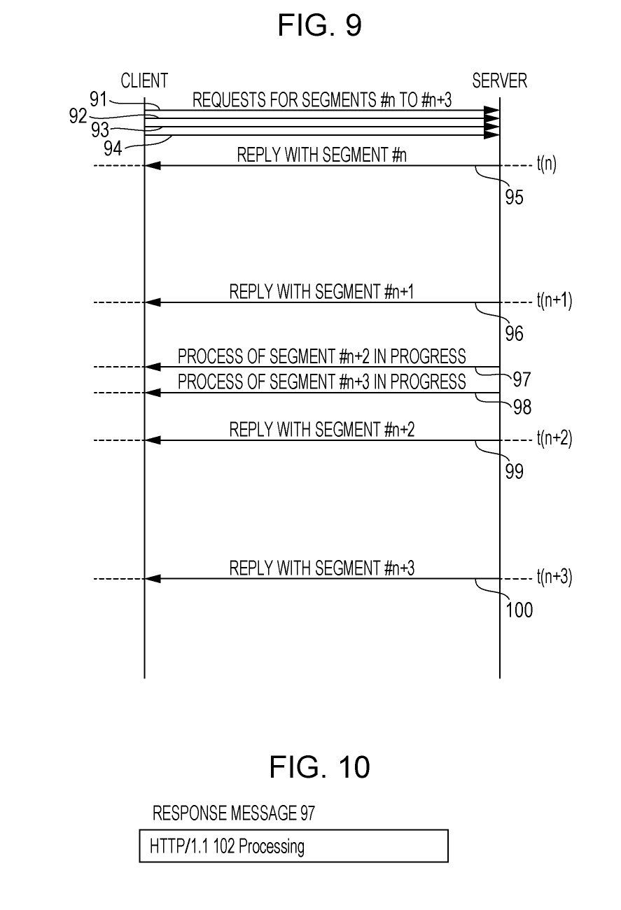

Next, an operation sequence of the server 1 and the client 2 that notifies the status that indicates a process is in progress and an HTTP message for notifying the status that indicates that a process is in progress will be described based on FIGS. 9 and 10. FIG. 9 is a diagram that illustrates one example of the operation sequence of the server 1 and the client 2 that notifies the status that indicates that a process is in progress. Further, FIG. 10 is a diagram that illustrates one example of the HTTP message that notifies the status that indicates that a process is in progress.

Here, similarly to a case illustrated in FIGS. 6 and 7, it is assumed that the client 2 refers to the MPD 70, forms requests for four segments #n to #n+3 into a pipeline, and transmits that before delivery time t(n) of segment #n.

As illustrated in FIGS. 9 and 10, the client 2 first refers to the MPD 70, forms request messages 91 to 94 to request transmission of segments #n to #n+3 into a pipeline, and transmits that to the server 1 before delivery time t(n).

The server 1 waits until the delivery times of segments #n to #n+3 because the request messages 91 to 94 request transmission of the segments. Then, at delivery time t(n) of segment #n, the server 1 transmits a response message 95 that contains the data body of segment #n as a reply to the request message 91 to the client 2, and the client 2 receives segment #n.

Further, at delivery time t(n+1) of segment #n+1, the server 1 transmits a response message 96 that contains the data body of segment #n+1 as a reply to the request message 92 to the client 2, and the client 2 receives segment #n+1.

Here, if the client 2 waits for replies to the request messages 93 and 94 until delivery times t(n+2) and t(n+3) of segments #n+2 and #n+3, the client 2 times out with both of the delivery times. Thus, the server 1 transmits, to the client 2, response messages 97 and 98 that indicate a status that indicates that processes are in progress to the request messages 93 and 94 before the time-outs. The client 2 receives the response messages 97 and 98, thus does not time out, and waits for the replies to the request messages 93 and 94.

Then, at delivery time t(n+2) of segment #n+2, the server 1 transmits a response message 99 that contains the data body of segment #n+2 as the reply to the request message 93 to the client 2, and the client 2 receives segment #n+2. Further, at delivery time t(n+3) of segment #n+3, the server 1 transmits a response message 100 that contains the data body of segment #n+3 as the reply to the request message 94 to the client 2, and the client 2 receives segment #n+3.

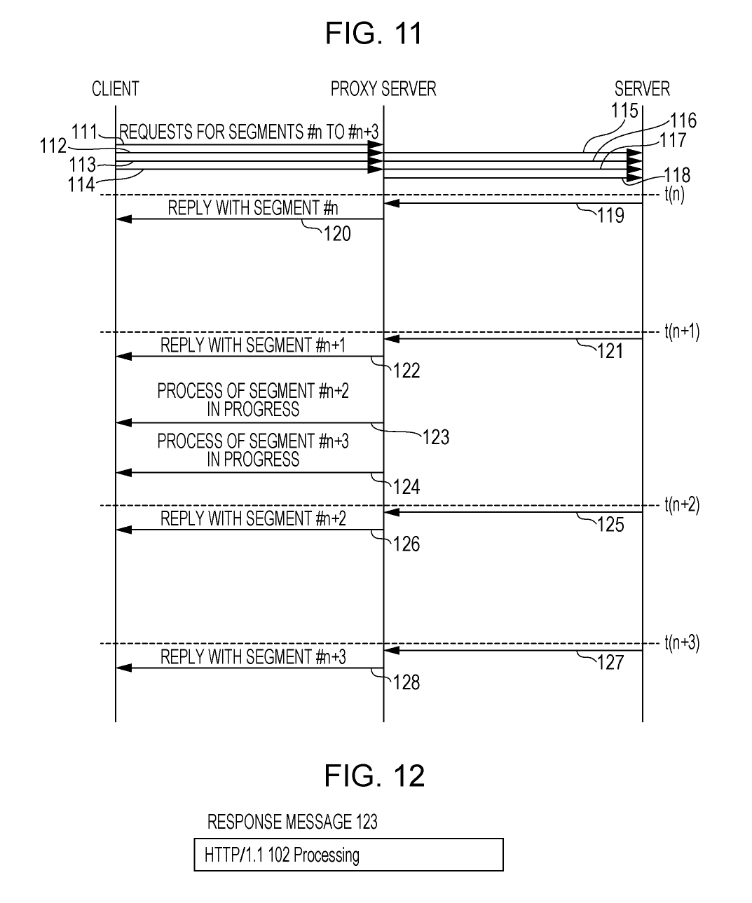

Next, an operation sequence of the server 1, the client 2, and the proxy server 3 and an HTTP message in a case where the proxy server 3 is included as illustrated in FIG. 8 will be described based on FIGS. 11 and 12. FIG. 11 is a diagram that illustrates one example of the operation sequence of the server 1, the client 2, and the proxy server 3 that notifies the status that indicates that a process is in progress. Further, FIG. 10 is a diagram that illustrates one example of the HTTP message that notifies the status that indicates that a process is in progress.

As illustrated in FIGS. 11 and 12, the client 2 first refers to the MPD 70, forms request messages 111 to 114 to request transmission of segments #n to #n+3 into a pipeline, and transmits that to the proxy server 3 before delivery time t(n). The proxy server 3 receives the request messages 111 to 114, forms request messages 115 to 118 to request transmission of segments #n to #n+3 into a pipeline, and transmits that to the server 1.

The server 1 waits until the delivery times of segments #n to #n+3 because the request messages 115 to 118 request transmission of the segments. Then, at delivery time t(n) of segment #n, the server 1 transmits a response message 119 that contains the data body of segment #n as a reply to the request message 115 to the proxy server 3. The proxy server 3 receives the response message 119 and transmits a response message 120 that contains the data body of segment #n as a reply to the request message 111 to the client 2, and the client 2 receives segment #n.

Further, at delivery time t(n+1) of segment #n+1, the server 1 transmits a response message 121 that contains the data body of segment #n+1 as a reply to the request message 116 to the proxy server 3. The proxy server 3 receives the response message 121 and transmits a response message 122 that contains the data body of segment #n+1 as a reply to the request message 112 to the client 2, and the client 2 receives segment #n+1.

Here, if the client 2 waits for replies to the request messages 113 and 114 until delivery times t(n+2) and t(n+3) of segments #n+2 and #n+3, the client 2 times out with both of the delivery times. Thus, the proxy server 3 transmits, to the client 2, response messages 123 and 124 that indicate a status that indicates that processes are in progress to the request messages 113 and 114 before the time-outs. The client 2 receives the response messages 123 and 124, thus does not time out, and waits for the replies to the request messages 113 and 114.

Then, at delivery time t(n+2) of segment #n+2, the server 1 transmits a response message 125 that contains the data body of segment #n+2 as a reply to the request message 117 to the proxy server 3. The proxy server 3 receives the response message 125 and transmits a response message 126 that contains the data body of segment #n+2 as a reply to the request message 113 to the client 2, and the client 2 receives segment #n+2.

Further, at delivery time t(n+3) of segment #n+3, the server 1 transmits a response message 127 that contains the data body of segment #n+3 as a reply to the request message 118 to the proxy server 3. The proxy server 3 receives the response message 127 and transmits a response message 128 that contains the data body of segment #n+3 as a reply to the request message 114 to the client 2, and the client 2 receives segment #n+3.

[Third Modification]

In this embodiment, the server 1 determines whether or not the segment is in the deliverable state by referring to the MPD and based on the delivery time of the segment. However, the server 1 is not limited to this. For example, the client 2 may add the delivery time of the segment to the request that requests transmission of the segment. In this case, the server 1 determines whether or not the segment is in the deliverable state based on the delivery time of the segment that is added to the request.

For example, the client 2 may add segment delivery time information that indicates the delivery time of the segment by using an extension header of an HTTP request message. Specifically, an attribute “X-Available” may be described in a header of an HTTP request message, and the delivery time t(n) of the segment may thereby be described as the attribute value.

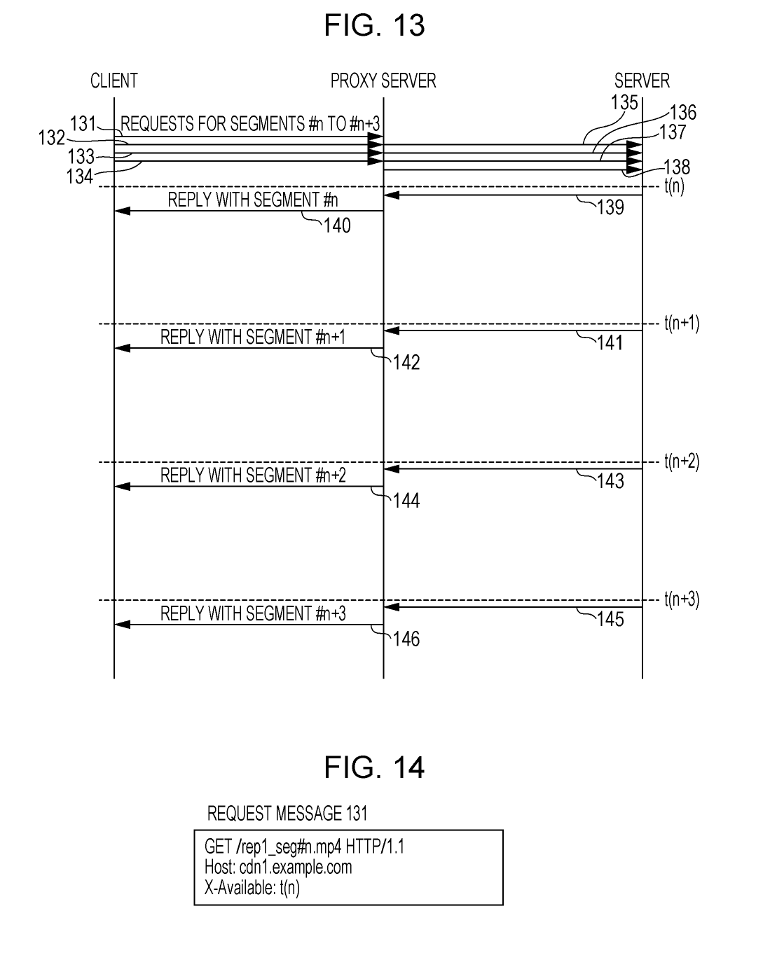

Next, an operation sequence in a case where the server 1 determines whether or not the segment is in the deliverable state based on the delivery time of the segment that is added to the request, and an HTTP request message to which the delivery time of the segment is added will be described based on FIGS. 13 and 14. FIG. 13 is a diagram that illustrates one example of the operation sequence in a case where the server 1 determines whether or not the segment is in the deliverable state based on the delivery time of the segment that is added to the request. Further, FIG. 14 is a diagram that illustrates one example of the HTTP request message to which the delivery time of the segment is added.

Here, similarly to a case illustrated in FIGS. 6 and 7, it is assumed that the client 2 refers to the MPD 70, forms requests for four segments #n to #n+3 into a pipeline, and transmits that before delivery time t(n) of segment #n. Further, as illustrated in FIG. 8, the client 2 transmits the request via the proxy server 3.

As illustrated in FIGS. 13 and 14, the client 2 first refers to the MPD 70, forms request messages 131 to 134 to request transmission of segments #n to #n+3 into a pipeline, and transmits that to the proxy server 3 before delivery time t(n). The proxy server 3 receives the request messages 131 to 134, forms request messages 135 to 138 to request transmission of segments #n to #n+3 into a pipeline, and transmits that to the server 1.

The server 1 waits until the delivery times of segments #n to #n+3 that are added to the request messages 135 to 138 because the request messages 135 to 138 request transmission of the segments. Then, at delivery time t(n) of segment #n, the server 1 transmits a response message 139 that contains the data body of segment #n as a reply to the request message 135 to the proxy server 3. The proxy server 3 receives the response message 139 and transmits a response message 140 that contains the data body of segment #n as a reply to the request message 131 to the client 2, and the client 2 receives segment #n.

Further, at delivery time t(n+1) of segment #n+1, the server 1 transmits a response message 141 that contains the data body of segment #n+1 as a reply to the request message 136 to the proxy server 3. The proxy server 3 receives the response message 141 and transmits a response message 142 that contains the data body of segment #n+1 as a reply to the request message 132 to the client 2, and the client 2 receives segment #n+1.

Further, at delivery time t(n+2) of segment #n+2, the server 1 transmits a response message 143 that contains the data body of segment #n+2 as a reply to the request message 137 to the proxy server 3. The proxy server 3 receives the response message 143 and transmits a response message 144 that contains the data body of segment #n+2 as a reply to the request message 133 to the client 2, and the client 2 receives segment #n+2.

Further, at delivery time t(n+3) of segment #n+3, the server 1 transmits a response message 145 that contains the data body of segment #n+3 as a reply to the request message 138 to the proxy server 3. The proxy server 3 receives the response message 145 and transmits a response message 146 that contains the data body of segment #n+3 as a reply to the request message 134 to the client 2, and the client 2 receives segment #n+3.

Further, in a case where the client 2 transmits the request to the server 1 via the proxy server 3, the proxy server 3 may control a transmission timing of the request to the server 1 based on the delivery time of the segment that is added to the request transmitted from the client 2.

Specifically, the proxy server 3 does not transfer the request to the server 1 immediately after the proxy server 3 receives the request transmitted from the client 2 but waits until the delivery time of the segment that is added to the request. The proxy server 3 then transmits the request to the server 1 at the delivery time of the segment that is added to the request.

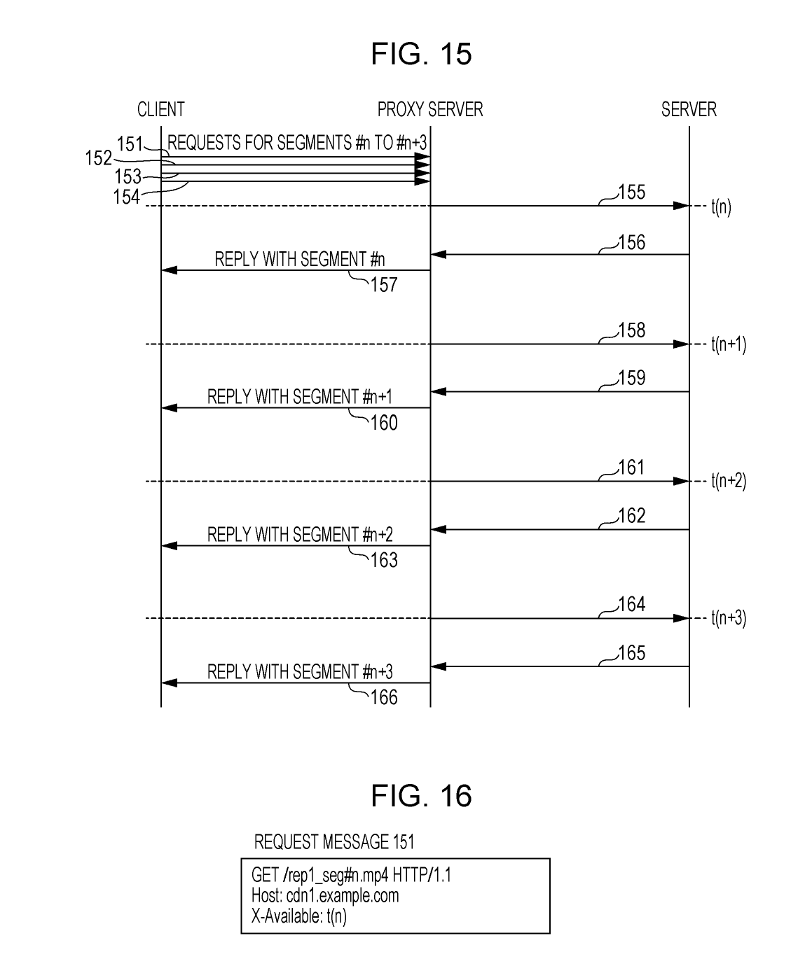

An operation sequence in a case where the proxy server 3 controls the transmission timing of the request to the server 1 based on the delivery time of the segment that is added to the request transmitted from the client 2, and an HTTP request message to which the delivery time of the segment is added will be described based on FIGS. 15 and 16. FIG. 15 is a diagram that illustrates one example of the operation sequence in a case where the proxy server 3 controls the transmission timings of the requests to the server 1 based on the delivery times of the segments that are added to the requests transmitted from the client 2. Further, FIG. 16 is a diagram that illustrates one example of the HTTP request message to which the delivery time of the segment is added.

As illustrated in FIGS. 15 and 16, the client 2 first refers to the MPD 70, forms request messages 131 to 134 to request transmission of segments #n to #n+3 into a pipeline, and transmits that to the proxy server 3 before delivery time t(n).

Here, the proxy server 3 waits until the delivery times of segments #n to #n+3 that are added to the request messages because the received request messages 151 to 154 request transmission of the segments. Then, at delivery time t(n) of segment #n, the proxy server 3 transmits a request message 155 to request transmission of segment #n to the server 1.

The server 1 transmits a response message 156 that contains the data body of segment #n as a reply to the request message 155 to the proxy server 3. The proxy server 3 receives the response message 156 and transmits a response message 157 that contains the data body of segment #n as a reply to the request message 151 to the client 2, and the client 2 receives segment #n.

Further, at delivery time t(n+1) of segment #n+1, the proxy server 3 transmits a request message 158 to request transmission of segment #n+1 to the server 1. The server 1 transmits a response message 159 that contains the data body of segment #n+1 as a reply to the request message 158 to the proxy server 3. The proxy server 3 receives the response message 159 and transmits a response message 160 that contains the data body of segment #n+1 as a reply to the request message 152 to the client 2, and the client 2 receives segment #n+1.

Further, at delivery time t(n+2) of segment #n+2, the proxy server 3 transmits a request message 161 to request transmission of segment #n+2 to the server 1. The server 1 transmits a response message 162 that contains the data body of segment #n+2 as a reply to the request message 161 to the proxy server 3. The proxy server 3 receives the response message 162 and transmits a response message 163 that contains the data body of segment #n+2 as a reply to the request message 153 to the client 2, and the client 2 receives segment #n+2.

Further, at delivery time t(n+3) of segment #n+3, the proxy server 3 transmits a request message 164 to request transmission of segment #n+3 to the server 1. The server 1 transmits a response message 165 that contains the data body of segment #n+3 as a reply to the request message 164 to the proxy server 3. The proxy server 3 receives the response message 165 and transmits a response message 166 that contains the data body of segment #n+3 as a reply to the request message 154 to the client 2, and the client 2 receives segment #n+3.

[Supplement]

The present invention is not limited to the above-described embodiment, and various modifications are possible within the scope of the claims. That is, embodiments that are obtained by combining appropriately modified technical means within the scope of the claims are included in the technical scope of the present invention.

Finally, the blocks of the server 1 and the client 2, particularly, the server control portion 11 and the client control portion 41 may be configured with hardware logic or may be realized with software by using CPUs as described below.

That is, the server 1 and the client 2 include central processing units (CPU) that executes commands of control programs that realize the functions, read only memories (ROM) that store the programs, random access memories (RAM) for expanding the programs, storage devices (recording media) such as memories that store the programs and various kinds of data, and so forth. An object of the present invention may be achieved by supplying the recording media that record program codes (executable programs, intermediate code programs, and source programs) of the control programs of the server 1 and the client 2 as software to realize the above-described functions in a computer-readable manner to the server 1 and the client 2 and by allowing their computers (or the CPUs or MPUs) to read out and execute the program codes recorded in the recording media.

As the recording medium, for example, tapes such as magnetic tape and cassette tape, disks that include magnetic disks such as Floppy® disk and hard disk and optical disks such as CD-ROM, MO, MD, DVD, and CD-R, cards such as IC card (including memory card) and optical card, semiconductor memories such as mask ROM, EPROM, EEPROM®, and flash ROM, and so forth may be used.

Further, the server 1 and the client 2 may be configured to be capable of connecting with a communication network and may supply the program codes via the communication network. As the communication network, although not particularly limited, for example, the Internet, an intranet, an extranet, a LAN, an ISDN, a VAN, a CATV communication network, a virtual private network, a telephone line network, a mobile communication network, a satellite communication network, and so forth may be used. Further, as a transmission medium that configures the communication network, although not particularly limited, for example, wired communication such as IEEE 1394, a USB, power line communication, a cable TV line, a telephone line, and an ADSL line and wireless communication such as infrared rays such as IrDA and a remote controller, Bluetooth®, the 802.11 radio, an HDR, a cellular phone network, a satellite line, and a terrestrial digital network may be used. The present invention may be realized by a mode of computer data signals embedded in a carrier in which the program codes are realized by electronic transmission.

### INDUSTRIAL APPLICABILITY

The present invention may be used for a content transmission device that transmits a content of the MPEG-DASH standard and a content playback device that obtains and plays the content.

### REFERENCE SIGNS LIST

1 server
2 client
3 proxy server
4 MPD storage device
5 segment storage device
6, 6a content delivery system
21 content obtainment portion
22 content transmission portion (transmission means)
51 content obtainment portion (obtainment means)
52 content playback portion

1. A content transmission device that transmits a content which is configured with plural segments to a content playback device on a segment-by-segment basis, the content transmission device comprising:
transmission means that transmits a response to the content playback device as a reply to a request in a case where the request is received from the content playback device,
wherein in a case where the request requests transmission of a segment, the transmission means waits until the segment is in a deliverable state and transmits a response that contains the segment to the content playback device after the segment is in the deliverable state.

2. The content transmission device according to claim 1, wherein the transmission means determines whether or not a segment is in the deliverable state based on content management information that is associated with the content.

3. The content transmission device according to claim 1, wherein the transmission means determines whether or not a segment is in the deliverable state based on a delivery time of the segment that is added to the request.

4. The content transmission device according to claim 1, wherein in a case where the request requests transmission of a segment and a predetermined time or longer is taken until the segment is in the deliverable state after the request is received, the transmission means notifies the content playback device of a status that indicates that a process is in progress.

5. A content playback device that obtains a content which is configured with plural segments from a content transmission device on a segment-by-segment basis and plays the content, the content playback device comprising:
obtainment means that transmits a request that requests transmission of each of the segments to the content transmission device and obtains a response that contains the segment as a reply to the request,
wherein the obtainment means transmits requests that request transmission of the segments before delivery times of the segments.

6. The content playback device according to claim 5, wherein, before obtaining a response to a request that requests transmission of a segment whose playback sequence is earlier is completed, the obtainment means transmits a request that requests transmission of a segment whose playback sequence is later.

7. The content playback device according to claim 6, wherein the obtainment means transmits plural requests that request transmission of segments by forming the plural requests into a pipeline.

8. The content playback device according to claim 5, wherein the obtainment means transmits the request to which a delivery time of a segment is added.

9. (canceled)

10. A relay device that is interposed between a content playback device and a content transmission device, the relay device comprising:
transfer means that transfers a request which is transmitted from the content playback device to the content transmission device and transfers a response which is transmitted from the content transmission device as a reply to the request to the content playback device,
wherein a content is configured with plural segments, and
in a case where the request which is transmitted from the content playback device requests transmission of a segment, the transfer means waits until the segment is in a deliverable state and transmits the request to the content transmission device after the segment is in the deliverable state.

11. The relay device according to claim 10, wherein in a case where the request which is transmitted from the content playback device requests transmission of a segment and a predetermined time or longer is taken until a response that contains the segment is obtained from the content transmission device after the request is received, the transfer means notifies the content playback device of a status that indicates that a process is in progress.

12. The relay device according to claim 10, wherein in a case where the request which is transmitted from the content playback device requests transmission of a segment and a delivery time of the segment is added to the request, the transfer means transmits the request to the content transmission device after the delivery time of the segment.

13-16. (canceled)

17. A control program that causes the content transmission device according to claim 1 to operate and causes a computer to function as the means.

18. A control program that causes the content playback device according to claim 5 to operate and causes a computer to function as the means.

19. A computer-readable recording medium that stores the control program according to claim 17.
